(19) United States
(12) Patent Application Publication
(10) Pub. No.: US 2009/0064734 A1
(43) Pub. Date: Mar. 12, 2009

(54) SURVEILLANCE DEVICE

(75) Inventor: Ulrich Zinner, Philadelphia (ZA)

Correspondence Address: CONNOLLY BOVE LODGE & HUTZ LLP, 1875 EYE STREET, N.W., SUITE 1100, WASHINGTON, DC, 20006, US

(73) Assignee: Bell-Oak Investment (Proprietary) Limited, Philadelphia (ZA)

(21) Appl. No.: 12/282,919

(22) PCT Filed: Mar. 14, 2007
(86) PCT No.: PCT/IB07/50872

§ 371 Date: Oct. 24, 2008

(30) Foreign Application Priority Data
Mar. 14, 2006 (ZA) 2006/02119

(51) Int. Cl. E05B 65/00

(52) U.S. Cl. 70/57.1

(57) ABSTRACT

An EAS tag is provided, which includes a tack with a shank that can enter an internal cavity of a tag body. One or more sensors are housed inside the cavity and the body defines one or more key apertures through which detacher keys can pass into the cavity. The tag includes a lock mechanism inside the cavity that is displaceable between a lock condition in which the end of the shank is held captive within the lock mechanism a free condition in which the shank can be withdrawn. The tag further includes two or three release mechanisms, a first of which is configured to release the lock mechanism by a key entering the cavity. The second and/or third release mechanisms can also be key operated or can use a magnetic field to displace a lock body to release the lock mechanism.

### FIELD OF THE INVENTION

This invention relates to electronic article surveillance (EAS) security devices or security tags that can be applied to articles such as merchandise to inhibit theft or pilfering. In particular, the invention relates to an EAS tag with an improved locking mechanism and a method of using the EAS tag.

### BACKGROUND TO THE INVENTION

Security devices in the form of tags that can be attached to merchandise in EAS systems are widely used to alert retailers to unauthorised removal of tagged merchandise from their premises. One such EAS device is known as a “hard tag” and includes a rigid body housing an EAS marker (also known in the art as a “sensor”) and a tack. The tack has a shank with a sharp end that can pass through an article of merchandise and that can be received in an aperture in the tag body, where it is held firmly to prevent removal of the tag from the article of merchandise. When the merchandise may legitimately leave the premises under surveillance, the tag is removed from the article of merchandise with a purpose-built detacher, which releases the tack to be withdrawn from the body. The EAS tag can be configured as a disposable or re-usable tag.

One mechanism for the attachment and removal of a re-usable hard tag that is commonly used includes a body with an internal lock mechanism. In order to release the lock mechanism, the tag is placed in a tag detacher device, in which part of the tag body fits snugly and a curved probe or key is inserted into the tag body, to pivot a detent of the lock mechanism.

The large scale use of tags with this configuration has had the result that many retailers already have tag detacher devices that are configured to receive the part of this particular shape of tag body in which the lock mechanism is housed and to penetrate the tag body with the key. Accordingly, it would be preferable if the shapes of new tag bodies are such that they are compatible with these existing tag detachers.

The needs have arisen for EAS tags that can be detached by simpler means and for EAS tags that can use sensors that are different from those of existing commonly used tags. However, as mentioned above, if newly devised tags are not compatible with existing EAS systems, especially with existing detachers, retailer would have to incur substantial costs in acquiring new detachers. Further, there is a requirement that EAS tags should preferably be as small and compact as possible.

The present invention seeks to provide an EAS tag that is compact and versatile and that can be used in combination with new tag detachers and/or with conventional tag detachers. The invention further seeks to provide an EAS tag that can house multiple sensors, preferably different types of sensors.

### SUMMARY OF THE INVENTION

According to the present invention there is provided an EAS tag which includes:

a fastener with a shank that can be passed through an aperture in an article to be tagged;

a body defining an internal cavity and defining at least one shank aperture through which the end of the shank can pass into the cavity and defining at least one key aperture through which a key of a detacher can pass;

at least one sensor disposed inside the cavity;

a lock mechanism disposed inside the cavity that is configured to receive the shank at least in part and that is displaceable between a lock condition in which the shank is held captive within the lock mechanism and a free condition in which the shank can be withdrawn from the lock mechanism; and

a first release mechanism that is configured to release the lock mechanism from its lock condition to its free condition, by a key passing into the cavity through the key aperture;

wherein said tag further includes at least a second release mechanism that is configured to release the lock mechanism from its lock condition to its free condition.

The lock mechanism may include a lock body that is displaceable between a lock position and a free position, corresponding to the lock condition and the free condition, respectively, of the lock mechanism.

The first release mechanism may include means for displacing the lock body towards its free position, upon inserting a first key into the cavity of the tag body and the means for displacing the lock body may include a cam that is configured to be moved by the first key and that defines a cam surface that acts upon the lock body to displace it towards its free position.

In one embodiment of the invention, the lock body may be magnetically attractable and the second release mechanism may be configured to allow the lock body to be displaced towards its free position, upon being attracted by a magnetic field of a predetermined strength. The second release mechanism may include means for generating the magnetic field.

Instead, in another embodiment of the invention, the second release mechanism may include means for displacing the lock body towards its free position, upon inserting a second key into the cavity of the tag body. The means for displacing the lock body may include a cam that is configured to be moved by the second key and that defines a cam surface that acts upon the lock body to displace it towards its free position, when the cam is moved by the second key. The first key may have a generally curved, elongate shape and the second key may have a generally straight, elongate shape.

In the version of the invention described directly above where the second release mechanism is configured to be activated by the second key, the tag may further include a third release mechanism that is configured to release the lock mechanism from its lock condition to its free condition.

The lock body may be magnetically attractable and the third release mechanism may be configured to allow the lock body to be displaced towards its free position, upon being attracted by a magnetic field of a predetermined strength. The third release mechanism may include means for generating the magnetic field.

The tag may include at least one biasing element, configured to bias the lock body towards its lock position, such as a compression spring.

The lock mechanism may include at least one displaceable detent and may define at least one taper surface that is angled relative to the axis of the shank when at least part of the shank is received inside the lock mechanism. The lock mechanism may be configured such that the detent is held between the shank and the taper surface to hold the shank captive inside the lock mechanism by way of a taper lock, when the lock mechanism is in the lock condition.

The detent may be a ball and the lock mechanism may include three of the balls that are circumferentially spaced. The lock body may be in the form of a cage defining radial apertures and the balls may be movably housed inside the radial apertures.

The tag may include a plurality of sensors and the sensors may be of different types, e.g. the sensors may be selected from electromagnetic sensors, acousto-magnetic sensors, radio frequency sensors, radio frequency identification sensors, and the like.

The body may define at least one storage recess in which the end of the shank can be received when the tag is not in use.

### BRIEF DESCRIPTION OF THE DRAWINGS

For a better understanding of the present invention and to show how it may be carried into effect, the invention will now be described by way of non-limiting example with reference to the accompanying drawings, in which:

FIG. 1 is an exploded view of an EAS tag in accordance with a first embodiment of the present invention, from one end;

FIG. 2 is an another exploded view of the tag of FIG. 1, from an opposite end;

FIG. 3 is a top plan view of the tag of FIG. 1, with the top part of the tag body removed, showing operation of the first release mechanism;

FIG. 4 is a top plan view of the tag of FIG. 1, with the top part of the tag body removed, showing operation of the second release mechanism; and

FIG. 5 is a three dimensional view of an EAS tag in accordance with a second embodiment of the present invention, during operation of the third release mechanism.

### DETAILED DESCRIPTION OF THE DRAWINGS

Referring to the drawings, an EAS tag in accordance with the present invention is generally indicated by reference numeral 10.

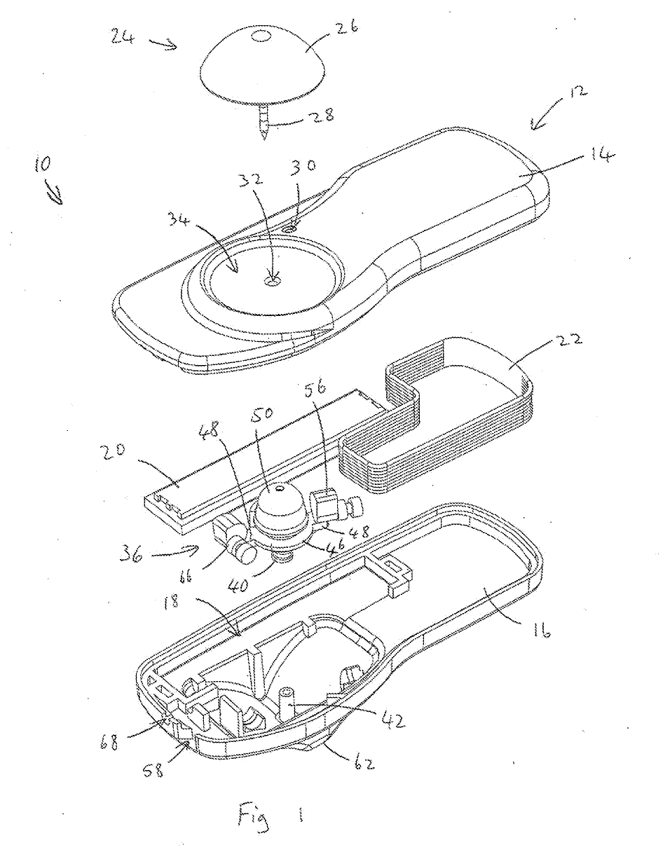

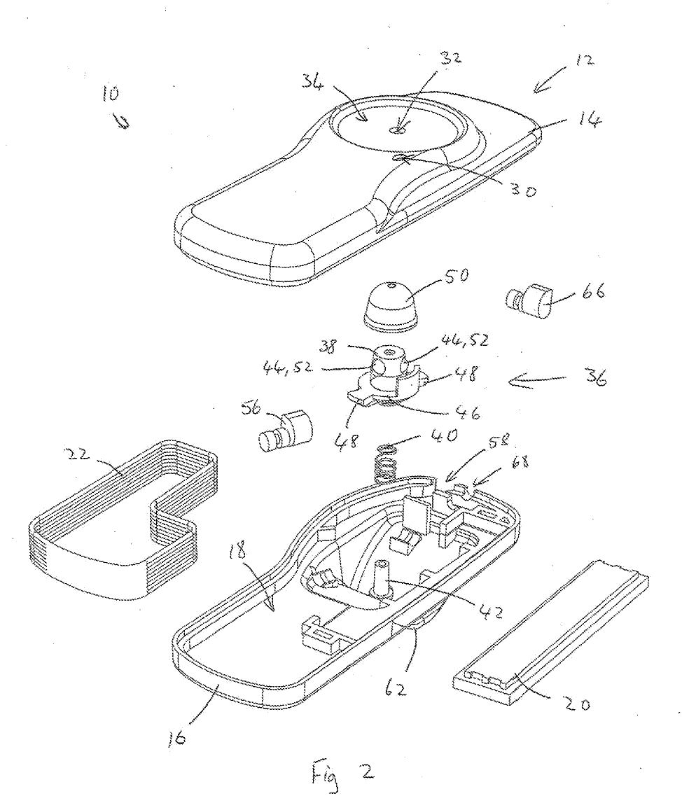

Referring to FIGS. 1 and 2, the tag 10 includes a tag body 12, comprising an upper part 14 and a lower part 16 of a hard plastic material that are fixedly attached together, e.g. by ultrasonic welding or with adhesive. The body 12 defines an internal cavity 18 in which two EAS markers or sensors are housed. The first sensor is in the form of an acousto-magnetic (EM) sensor 20 and the second sensor is in the form of an electromagnetic (EM) sensor 22 or coil. However, it is to be appreciated that the tag 10 can include any number of sensors, depending on its intended use. Preferably, the tag 10 would include different types of sensors, so that it is more versatile and can be used in combination with different EAS systems, without the need for any alteration to the tag 10.

The tag 10 includes a fastener in the form of a tack 24 with a wide, disc shaped head 26 and a shank 28 with circumferential ribs and a sharp point. A shank aperture 32 is defined in the upper part 14 of the body 12, through which the end of the shank 28 can pass into the cavity 18 and a recess 34 is defined around the shank aperture 32 into which the head 26 of the tack 24 is partly received when the shank is entered into the shank aperture. This is intended to make it more difficult for objects to be inserted between the body 12 and the head 26 to pry the tack 24 and body apart.

Further, a storage recess 30 is defined in the upper part 14 of the body 12, spaced from the shank aperture 32, so that the end of the shank can be received in the storage recess when the tag 10 is not in use, to prevent the tack 24 and body 12 from becoming separated and to prevent accidental pricking with the end of the shank 28.

The tag 10 includes a lock mechanism inside the cavity 18 that is generally indicated in the drawings by reference numeral 36 and that is shown assembled in FIG. 1 and exploded in FIG. 2. The lock mechanism 36 is axially aligned with the shank aperture 32 and is configured to receive at least the part of the shank 28 closest to its end (i.e. the lower end of the shank) and to hold it selectively inside the cavity 18. To this end, the lock mechanism 36 is displaceable between a lock condition in which the shank 28 is held captive within the lock mechanism and a free condition in which the shank can be withdrawn from the lock mechanism.

The lock mechanism 36 includes a lock body 38 that is displaceable upwardly to a lock position corresponding to the lock condition of the lock mechanism and downwardly to a free position, corresponding to the free condition of the lock mechanism. The lock body 38 is made of a material that can be magnetically attracted and is urged upwardly, towards its lock position, by a biasing element in the form of a compression spring 40 that extends around a spigot 42. The lock element 38 has a central axial passage through it, into which the shank 28 is received when it enters the cavity 18. Around the passage, three radial apertures in the form of ball sockets 44 are defined and are circumferentially spaced at about 120°, such that the lock body 38 is in the form of a cage. Below the ball sockets 44, the lock body has a radial flange 46 and two protuberances 48 that extend from the flange.

The lock mechanism 36 further includes an inverted cup 50 with frusto-conical walls and with a central aperture. The cup 50 is received coaxially over the lock body 38 above the flange 46, such that the inner surfaces of the frusto-conical wall defines a taper surface relative to the common axis of the lock body and the cup, which is also the axis along which the shank 28 can enter the cavity 18. Three detents in the form of spheres or balls 52 are housed inside the ball sockets 44 and are movable in the radial direction.

In use, when the tag 10 is to be attached to an article, e.g. to prevent unwanted removal of the article from certain premises, the shank 28 is passed through an aperture in the article, its sharp end is inserted into the shank aperture 32 and the shank is inserted further until the head 26 is desirably close to the body 12, preferably received in the recess 34 with part of the tagged article pinched between the head 26 and the body 12.

When the shank 28 passes into the cavity 18 via the shank aperture 32, the lock mechanism is in its lock condition, with the lock body 38 and cup 50 urged upwardly by the spring 40. The shank 28 passes axially into the insides of the cup 50 and the lock body 38 and urges the balls 52 outwardly, against the tapered inner surface of the cup wall. The result is that the balls 52 are caught in a tapering cavity between the shank 28 and the tapered wall in abutment with both these surfaces and if an attempt is made to withdraw the shank upwardly, this is prevented by a taper lock in that the balls are prevented by the tapered shape of the cavity from rolling upwardly and if the balls were to roll upwardly by a small amount, the taper would cause any play to be taken up and their grip on the respective surfaces to increase. The shank 28 is thus held captive inside the lock mechanism 36 by the taper lock.

When the tag 10 is to be removed from the article, one of the release mechanisms that will be described below are operated to move the lock body 38 downwardly to its free position so that the balls 52 are allowed to roll downwardly and/or the lock body 38 is moved downwardly relative to the cup 50, to an extent that is sufficient to release the taper lock, so that the shank 28 is released from the lock mechanism 36 and can be withdrawn from the cavity 18 and from the tag body 12.

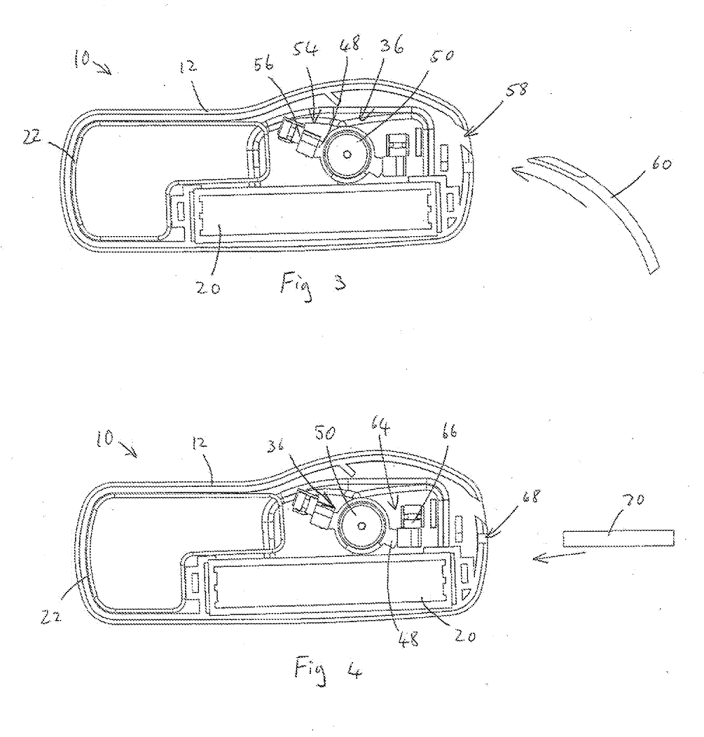

Referring to FIGS. 1, 2 and 3, the tag 10 includes a first release mechanism 54 that is configured to release the lock mechanism 36 by lifting the lock body 38. The first release mechanism includes a first cam element 56 that is rotatably mounted in the cavity 18, between retaining formations on the insides of the upper and lower parts 14, 16 of the body 12. The cam element 56 has a cam surface that abuts one of the protuberances 48.

A first key aperture 58 is defined in the body 12, through which a first key 60 can enter the cavity 18 along a curved path, so that the end of the first key presses against the first cam element 56 to rotate it. The rotation of the first cam element 56 causes its cam surface to press downwardly onto its associated protuberance 48 and thus to urge the lock body 38 downwardly and to release the lock mechanism 36.

The first key 60 has an elongate, curved shape and has a specific profile that is complemental to that of the first key aperture 58 and travels along a predetermined curved path as it enters the cavity 18. The configuration of the first key 60 and its movement are identical to those of conventional EAS systems, so that the first release mechanism 54 can be operated with the key 60 of a conventional tag detacher. To this end, the shape of the lower part 16 of the body 12 includes a protuberance 62 that is identical to those of conventional EAS tags and that allow the tags to be positioned correctly in the detachers, for the to key 60 to enter the aperture 58 along the correct path.

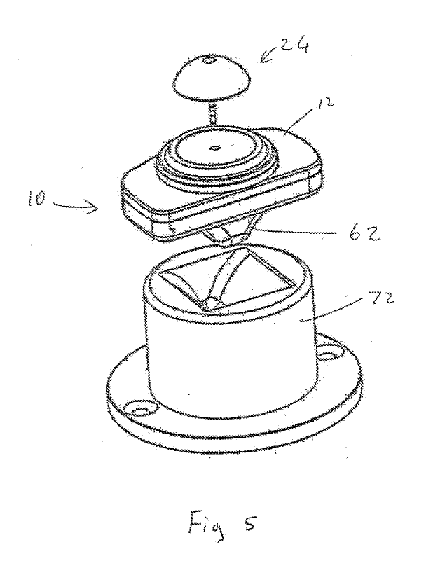

Referring to FIGS. 1, 2 and 4, the tag 10 includes a second release mechanism 64 that is similar to the first release mechanism and that is configured to release the lock mechanism 36 by lifting the lock body 38. The second release mechanism includes a second cam element 66 that is rotatably mounted in the cavity 18, between retaining formations on the insides of the upper and lower parts 14, 16 of the body 12. The cam element 66 has a cam surface that abuts one of the protuberances 48.

A second key aperture 68 is defined in the body 12, through which a second key 70 can enter the cavity 18 along a linear path, so that the end of the second key presses against the second cam element 66 to rotate it. The rotation of the second cam element 66 causes its cam surface to press downwardly onto its associated protuberance 48 and thus to urge the lock body 38 downwardly and to release the lock mechanism 36.

The second key 70 has a straight, elongate shape and has a specific profile that is complemental to that of the second key aperture 68 and travels axially along a predetermined linear path as it enters the cavity 18. The straight, axial configuration of the second key 70 and its movement are very simple and allows much simpler and less expensive tag detachers to be built that can include this key and its movement. The profiles of the second key 70 and its complementary profiled second key aperture 68, can be made very intricate, to prevent insertion of other objects into the second key aperture to release the lock mechanism.

Referring to FIGS. 1, 2 and 5, the tag 10 includes a third release mechanism in that the lock mechanism 36 can be released by attracting the lock body 38 downwardly by way of a magnetic field of a predetermined strength that is generated in a magnetic detacher 72, shown in FIG. 5 in use with a tag 10 that is shaped slightly differently from that shown in FIGS. 1 to 4. In order to prevent unauthorised operation of the third release mechanism, the tag 10 is configured such that a very strong magnetic field is required to release the lock mechanism 36.

Reference is made in the preceding description to first, second and third release mechanisms, but in different embodiments of the present invention, one of these lock mechanisms can be omitted. In particular, it is envisaged that either the first 54 or the second 64 release mechanisms can be omitted, in which case, what has been described herein above as the third release mechanism, will be the second release mechanism.

1. An EAS tag which includes:
a fastener with a shank that can be passed through an aperture in an article to be tagged;
a body defining an internal cavity and defining at least one shank aperture through which the end of the shank can pass into the cavity and defining at least one key aperture through which a key of a detacher can pass;
at least one sensor disposed inside the cavity;
a lock mechanism disposed inside the cavity that is configured to receive the shank at least in part and that is displaceable between a lock condition in which the shank is held captive within the lock mechanism and a free condition in which the shank can be withdrawn from the lock mechanism; and
a first release mechanism that is configured to release the lock mechanism from its lock condition to its free condition, by a key passing into the cavity through the key aperture;
wherein said tag further includes at least a second release mechanism that is configured to release the lock mechanism from its lock condition to its free condition.

2. A tag as claimed in claim 1, wherein the lock mechanism includes a lock body that is displaceable between a lock position and a free position, corresponding to the lock condition and the free condition, respectively, of the lock mechanism.

3. A tag as claimed in claim 2, wherein the first release mechanism includes means for displacing the lock body towards its free position, upon inserting a first key into the cavity of the tag body.

4. A tag as claimed in claim 3, wherein the means for displacing the lock body includes a cam that is configured to be moved by the first key and that defines a cam surface that acts upon the lock body to displace it towards its free position.

5. A tag as claimed in claim 2, wherein the lock body is magnetically attractable and the second release mechanism is configured to allow the lock body to be displaced towards its free position, upon being attracted by a magnetic field of a predetermined strength.

6. A tag as claimed in claim 5, wherein the second release mechanism includes means for generating a magnetic field.

7. A tag as claimed in claim 3, wherein the second release mechanism includes means for displacing the lock body towards it free position, upon inserting a second key into the cavity of the tag body.

8. A tag as claimed in claim 7, wherein the means for displacing the lock body includes a cam that is configured to be moved by the second key and that defines a cam surface that acts upon the lock body to displace it towards its free position, when the cam is moved by the second key.

9. A tag as claimed in claim 7, wherein the first key has a generally curved, elongate shape and the second key has a generally straight, elongate shape.

10. A tag as claimed in claim 7, wherein the tag further includes a third release mechanism that is configured to release the lock mechanism from its lock condition to its free condition.

11. A tag as claimed in claim 10, wherein the lock body is magnetically attractable and the third release mechanism is configured to allow the lock body to be displaced towards its free position, upon being attracted by a magnetic field of a predetermined strength.

12. A tag as claimed in claim 11, wherein the third release mechanism includes means for generating the magnetic field.

13. A tag as claimed in claim 2 wherein said tag includes at least one biasing element, configured to bias the lock body towards its lock position.

14. A tag as claimed in claim 13, wherein said biasing element is a compression spring.

15. A tag as claimed in claim 2 wherein said lock mechanism includes at least one displaceable detent and defines at least one taper surface that is angled relative to the axis of the shank when at least part of the shank is received inside the lock mechanism, the lock mechanism being configured such that the detent is held between the shank and the taper surface to hold the shank captive inside the lock mechanism by way of a taper lock, when the lock mechanism is in the lock condition.

16. A tag as claimed in claim 15, wherein said detent is a ball.

17. A tag as claimed in claim 16, wherein said lock mechanism includes three of the balls that are circumferentially spaced.

18. A tag as claimed in claim 17, wherein the lock body is in the form of a cage defining radial apertures and the balls are movable housed inside the radial apertures.

19. A tag as claimed in claim 1, wherein said tag includes a plurality of sensors.

20. A tag as claimed in claim 19, wherein the sensors are of different types.

21. A tag as claimed in claim 20, wherein the sensors are selected from electromagnetic sensors, acoustomagnetic sensors, radio frequency sensors and radio frequency identification sensors.

22. A tag as claimed in claim 1 wherein said body defines at least one storage recess in which the end of the shank can be received when the tag is not in use.
